(19) United States
(12) Patent Application Publication
(10) Pub. No.: US 2020/0405556 A1
(43) Pub. Date: Dec. 31, 2020

(54) RIDE VEHICLE PASSENGER TRANSFER SYSTEMS AND METHODS

(71) Applicant: Universal City Studios LLC, Universal City, CA (US)

(72) Inventors: Dionté Omar Henderson, Orlando, FL (US); Gregory Shellman Hall, Orlando, FL (US); Annina M. Kreiser, Orlando, FL (US); Tyler Scott Demyan, Harrisburg, PA (US)

(21) Appl. No.: 16/530,617

(22) Filed: Aug. 2, 2019

Related U.S. Application Data
(60) Provisional application No. 62/866,289, filed on Jun. 25, 2019.

(51) Int. Cl. A61G 7/10; A63G 4/00

(52) U.S. Cl. CPC A61G 7/1001; A61G 7/1059; A63G 4/00; A61G 7/103; A61G 7/1019; A61G 7/1046

(57) ABSTRACT

A passenger transfer system in accordance with present embodiments includes a mobile chair having a base portion with a plurality of wheels and a chair portion configured to support a passenger. The passenger transfer system further includes an elevation adjustment system and a transfer device. The elevation adjustment system is configured to adjust a height of the chair portion relative to the base portion. The transfer device is configured to extend laterally from an edge of the chair portion. The transfer device is further configured to support the passenger as the passenger transfers from the chair portion to a ride seat of a ride vehicle of an attraction of an amusement park.

### CROSS-REFERENCE TO RELATED APPLICATIONS

The present application claims the benefit of U.S. Provisional Application No. 62/866,289, entitled “RIDE VEHICLE PASSENGER TRANSFER SYSTEMS AND METHODS,” and filed Jun. 25, 2019, the disclosure of which is incorporated herein by reference for all purposes

### BACKGROUND

The present disclosure relates generally to the field of amusement parks.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Since the early twentieth century, amusement parks (or theme parks) have substantially grown in popularity. Amusement parks may include a limited number of attractions that can accommodate a wheelchair-using passenger in a wheelchair. Further, the few attractions that may accommodate such passengers may include ride vehicles having a limited number of seats capable of accommodating the passengers. Moreover, it is important for attractions to comply with the Americans with Disabilities Act (ADA). Additionally, the transfer of the passengers into such ride seats may be inefficient and/or difficult for the passengers.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In accordance with one embodiment, a passenger transfer system includes a mobile chair having a base portion with a plurality of wheels and a chair portion configured to support a passenger. The passenger transfer system further includes an elevation adjustment system and a transfer device. The elevation adjustment system is configured to adjust a height of the chair portion relative to the base portion. The transfer device is configured to extend laterally from an edge of the chair portion. The transfer device is further configured to support the passenger as the passenger transfers from the chair portion to a ride seat of a ride vehicle of an attraction of an amusement park.

In accordance with one embodiment, a mobile chair includes a base portion; an adjustable-height seat portion configured to support a passenger, wherein the adjustable-height seat portion is adjustable relative to the base portion between a first position and a second position on the base portion; one or more vertical stops fixedly coupled to the base portion at the second position; and a transfer device rotatably coupled to one or both of the base portion or the one or more vertical stops and configured to rotate between a storage position and a transfer position, wherein the transfer position of the transfer device is substantially coplanar with the second position of the adjustable-height seat portion and wherein the adjustable-height seat portion is configured to slide towards an edge of the transfer device and away from the base portion when in the second position

### DRAWINGS

These and other features, aspects, and advantages of the present disclosure will become better understood when the following detailed description is read with reference to the accompanying drawings in which like characters represent like parts throughout the drawings, wherein:

FIG. 1 is an schematic diagram of an embodiment of a mobile chair in a mobile configuration positioned adjacent to a ride vehicle of a ride system, in accordance with aspects of the disclosure;

FIG. 2 is a schematic view of an embodiment of the mobile chair of FIG. 1 in a transfer configuration, in accordance with aspects of the present disclosure;

FIG. 3 is a perspective view of an embodiment of the mobile chair of FIG. 1 in a mobile configuration, in accordance with aspects of the present disclosure;

FIG. 4 is a perspective view of an embodiment of the mobile chair of FIG. 3 in an intermediate configuration, in accordance with aspects of the present disclosure;

FIG. 5 is a perspective view of an embodiment of the mobile chair of FIG. 3 in a transfer configuration, in accordance with aspects of the present disclosure;

FIG. 6 is a perspective view of an embodiment of the mobile chair of FIG. 1 in a transfer configuration, wherein the mobile chair includes a transfer device that rotates from beneath or above a seat portion of the mobile chair in accordance with aspects of the present disclosure;

FIG. 7 is a perspective view of an embodiment of the mobile chair of FIG. 1 in a transfer configuration, wherein the mobile chair has a mounting element and an extension in accordance with aspects of the present disclosure;

FIG. 8 is a schematic view of an embodiment of the mobile chair of FIG. 1 in a transfer configuration, wherein a chair portion of the mobile chair is supported on an extension in accordance with aspects of the present disclosure; and

FIG. 9 is a schematic view of an embodiment of the mobile chair of FIG. 1 in a transfer configuration, wherein a seat portion of the mobile chair is supported on an extension in accordance with aspects of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features

The present disclosure provides, among other things, systems and methods configured to aid in the transfer of wheelchair-using passengers into ride vehicles. Generally, amusement parks may include a wide variety of attraction types. The attractions may similarly include a wide variety of ride vehicles configured to provide varying ride experiences. In some instances, wheelchair-using passengers may require extra assistance, time, and effort to board the ride vehicles (e.g., from a mobile chair), if they are able to board the ride vehicles at all. For some amusement parks, a select few attractions may include ride vehicles specifically designed to accommodate wheelchair-using passengers. For example, the ride vehicles of such attractions may include a ride seat or section configured to secure a wheelchair-using passenger and their wheelchair. Various constraints, such as dynamics of the attraction, may differ widely between attractions, which may necessitate a unique design for each attraction in aiding the boarding of wheelchair-using passengers. As such, the design and implementation of such ride vehicles may be costly, which may limit the number of such attractions included in an amusement park.

Accordingly, provided herein is a mobile chair configured to aid in the transfer of wheelchair-using passengers into a variety of ride vehicles. Generally, the wheelchair-using passenger may utilize the mobile chair by having the mobile chair positioned adjacent to a ride seat of a ride vehicle. The wheelchair-using passenger may then transfer laterally from the mobile chair into the ride seat. To this end, the mobile chair may be adjustable to accommodate the variety of ride vehicles. Particularly, a height of the mobile chair may be adjustable to account for varying heights of ride vehicles. The mobile chair may further include a transfer device. The transfer device may be configured to bridge a gap between the mobile chair and the ride vehicle to which the wheelchair-using passenger is attempting to transfer. In some embodiments, the transfer device may engage with the ride vehicle such that the transfer device is at least partially supported by the ride vehicle. The transfer device may be configured to provide support to the wheelchair-using passenger as the wheelchair-using passenger moves from the mobile chair to the ride vehicle across the transfer device. In some embodiments, portions of the mobile chair may be configured to translate across the transfer device while supporting the wheelchair-using passenger to aid in the transfer of the wheelchair-using passenger into the ride seat.

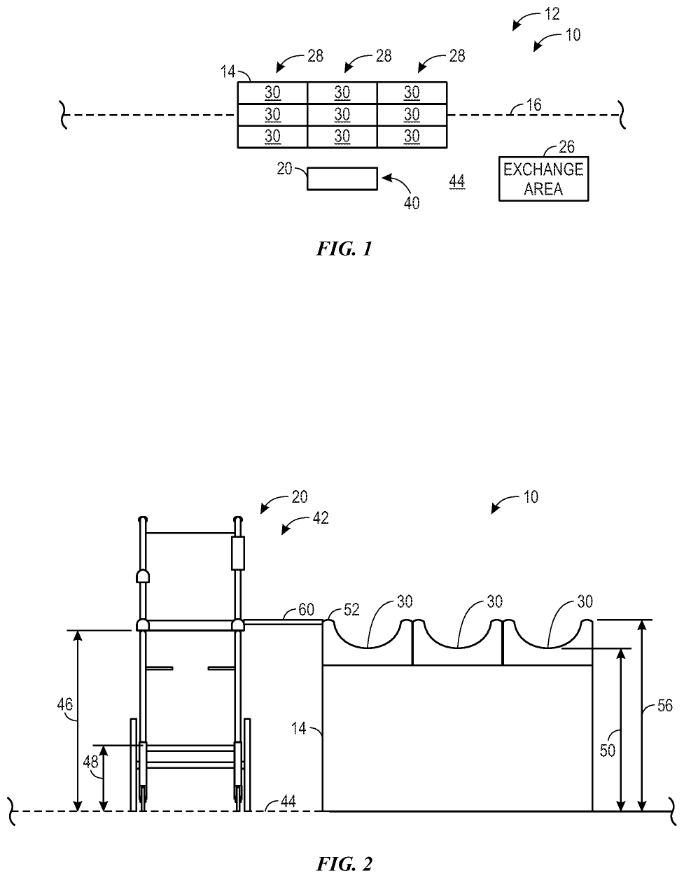

Keeping this in mind, FIG. 1 is schematic view of a loading zone 10 of an attraction 12 (e.g., a ride system). Generally, one or more ride vehicles 14 may travel along a path 16 (e.g., a loop) of the attraction 12 during a ride cycle, and then come to a stop at the loading zone 10 for loading and unloading of passengers. For example, passengers may load into the ride vehicle 14 while the ride vehicle 14 is stopped at the loading zone 10. Once the passengers are loaded into the ride vehicle 14, the ride vehicle 14 may travel along the path 16 during the ride cycle and arrive back at the loading zone 10 at the completion of the ride cycle. Once the ride vehicle 14 arrives back at the loading zone 10, passengers may unload from the ride vehicle 14 and new passengers may load into the ride vehicle 14 to start another ride cycle.

In some instances, the wheelchair-using passenger (referred to below as “passengers”) may attempt to board the ride vehicle 14. Accordingly, as will be appreciated, the passenger may utilize a mobile chair 20 to increase an ease and efficiency of boarding the ride vehicle 14. Indeed, as discussed in further detail below, the mobile chair 20 may include one or more features configured to aid in the transfer of the wheelchair-using passenger from the mobile chair 20 into the ride vehicle 14. As illustrated in the current embodiment, the mobile chair 20 may be positioned adjacent to the ride vehicle 14 while the wheelchair-using passenger transfers from the mobile chair 20 to the ride vehicle 14.

In some embodiments, the wheelchair-using passenger may also utilize the mobile chair 20 for travel throughout an amusement park having the attraction 12. In some embodiments, the passenger may utilize a separate personal mobile chair (e.g., wheelchair or other suitable device) to travel throughout the amusement park, and may utilize the mobile chair 20 when the passenger is at the attraction 12. That is, the passenger may transfer from their personal mobile chair, or a mobile chair available at the attraction, into the mobile chair 20 when the passenger arrives at the attraction. To this end, in some embodiments, the attraction 12 may include an exchange area 26 that the passenger may utilize to transfer from their personal mobile chair to the mobile chair 20. The exchange area 26 may include walls (e.g., borders) configured to block other passengers that are located outside of the exchange area 26 from viewing inside the exchange area 26. In this manner, the passenger utilizing the exchange area 26 may be provided with privacy while the passenger transfers from their personal mobile chair to the mobile chair 20. Once the passenger is in the mobile chair 20, the mobile chair 20 may be positioned adjacent to the ride vehicle 14 for transfer into the ride vehicle, as shown.

In the currently illustrated embodiment, the ride vehicle 14 includes three rows 28 with each row 28 having three seats 30. However, it is to be understood that the ride vehicle 14 may have any suitable number of rows 28 and ride seats 30. Generally, the mobile chair 20 may be positioned adjacent to any one of the ride seats 30 disposed at an edge of one of the rows 28. Indeed, the mobile chair 20 may be configured to be utilized with any ride seat 30. In this way, the passenger in the mobile chair 20 may choose any of the seats 30 to transfer into from the mobile chair 20.

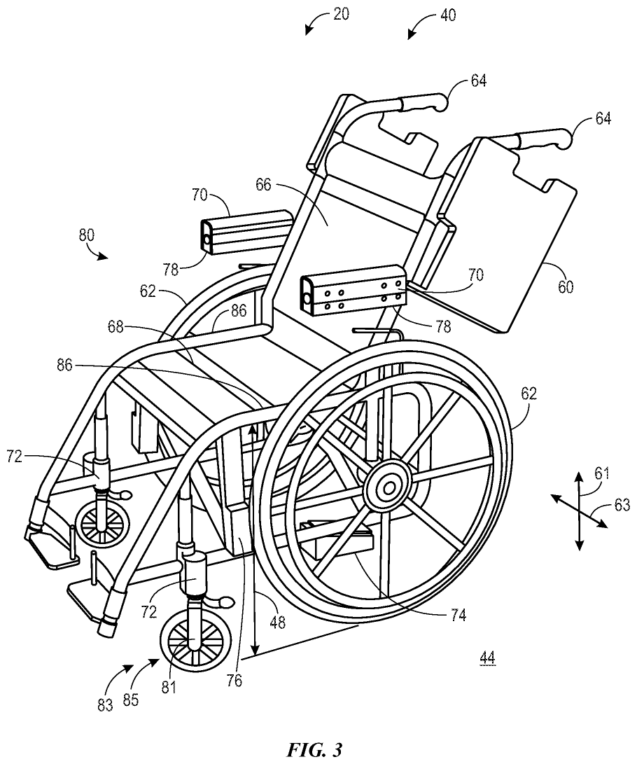

The mobile chair 20 may transition between a mobile configuration 40, as shown in FIG. 1, and a transfer configuration 42, as shown in FIG. 2 and discussed in further detail below. While the mobile chair 20 is in the mobile configuration 40, the mobile chair 20 may be configured to move along a floor 44 of the loading zone 10, or other surface, such as when the mobile chair 20 is being utilized in the exchange area 26, when the mobile chair 20 is being positioned adjacent to the seat 30 of the ride vehicle 14, or when the mobile chair 20 is being moved about the loading zone 10. Further, while in the mobile configuration 40, the mobile chair 20 may be pushed by a person, may be moved through physical input from the passenger disposed within the mobile chair 20, or may be moved through input from an internal drive system.

Once the mobile chair 20 is positioned adjacent to the ride seat 30 of the ride vehicle 14, the mobile chair 20 may be transitioned from the mobile configuration 40 to the transfer configuration 42 to allow the passenger to transfer from the mobile chair 20 to the ride seat 30. To illustrate, FIG. 2 is a schematic view of the mobile chair 20 in the transfer configuration 42. As shown, while the mobile chair 20 is in the transfer configuration 42, the mobile chair 20 may be positioned adjacent to one of the ride seats 30 of the ride vehicle 14 on the floor 44 of the loading zone 10. Further, while the mobile chair 20 is in the transfer configuration 42, the mobile chair 20 may be elevated at a transfer height 46. Particularly, the mobile chair 20 may be disposed at a mobile height 48 while the mobile chair 20 is in the mobile configuration 40 (FIG. 1). The mobile chair 20 may then be elevated to the transfer height 46 once the mobile chair 20 is positioned adjacent to the ride seat 30 to reach the transfer configuration 42, which facilitates transferring the passenger into the ride seat 30.

As shown, the ride seat 30 may be positioned at a ride seat height 50 from the floor 44. In some instances, the ride seat height 50 may inconvenience some passengers (e.g., wheelchair-using passengers) when transferring into the ride seat 30 from the floor 44. For example, passengers utilizing standard mobile chairs may first transfer (e.g., stand on) to the floor 44 before transferring into the ride seat 30. However, this may be difficult or impossible for some passengers. Further, in some embodiments, the ride seat 30 may include one or more walls 52 disposed at edges of the ride seats 30. A wall height 56 of the wall 52 may be disposed further vertically above the ride seat height 50 from the floor 44. Accordingly, it may be particularly difficult for such passengers to overcome the wall height 56 and transfer into the ride seat 30 when transferring from the floor 44. However, as discussed herein, passengers may utilize the mobile chair 20 to transfer directly from the mobile chair 20 into the ride seat 30 (e.g., without first transferring to the floor 44). Particularly, the mobile chair 20 allows passengers to transfer from the transfer height 46 of the mobile chair 20 into the ride seat 30. The height difference between the mobile chair 20 at the transfer height 46 and ride seat height 50 of the ride seat 30 may be substantially less than the wall height 56 or the ride seat height 50 relative to the floor 44. As such, the elevated height of the mobile chair 20 may facilitate passengers loading into the ride vehicle 14. As discussed in further detail below, the transfer height 46 of the mobile chair 20 may be selected based on the ride seat height 50 of the ride vehicle 14, which may vary between attractions of the amusement park.

The mobile chair 20 may further include a transfer device 60 (e.g., laterally-extending support structure, such as a platform or rod). The transfer device 60 may be deployed to bridge a gap between the mobile chair 20 and the ride seat 30, as shown. Particularly, the passenger may move across the transfer device 60 while loading into the ride seat 30 from the mobile chair 20. In some embodiments, the transfer device 60 may be detachable from the mobile chair 20. In some embodiments, the transfer device 60 may contact and/or couple to the wall 52 of the ride seat 30. The transfer device 60 may be at least partially supported by the ride vehicle 14 while the passenger utilizes the transfer device 60.

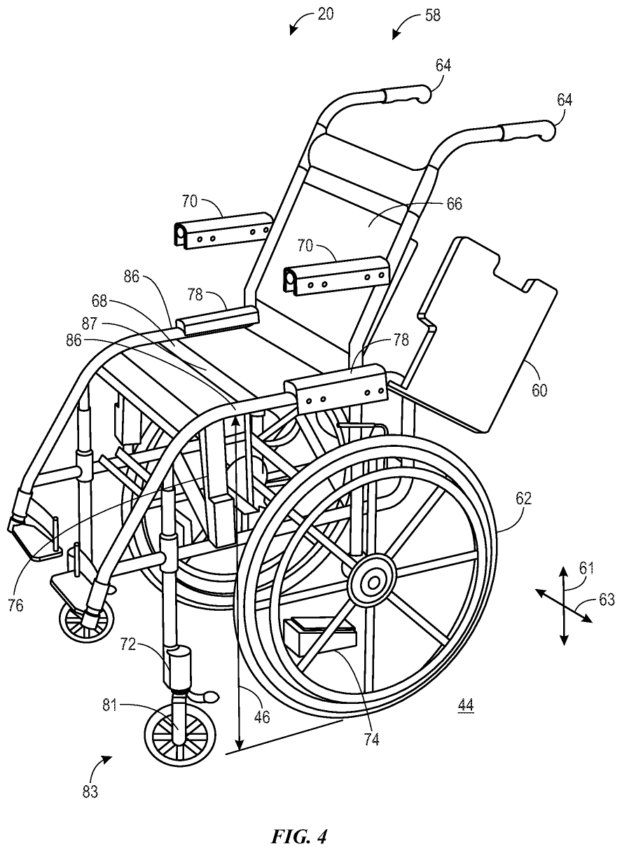

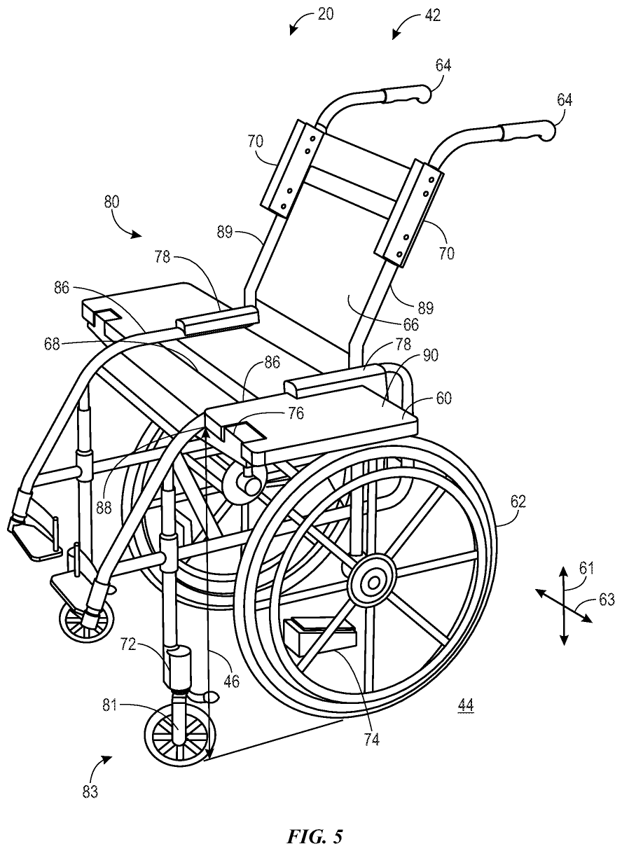

FIGS. 3-5 are perspective views of an embodiment of the mobile chair 20 as the mobile chair 20 transitions between the mobile configuration 40 and the transfer configuration 42. For example, FIG. 3 is a perspective view of the mobile chair 20 in the mobile configuration 40, FIG. 4 is a perspective view of the mobile chair 20 in an intermediate configuration 58, and FIG. 5 is a perspective view of the mobile chair 20 in the transfer configuration 42. In the following discussion, reference may be made to a vertical direction or axis 61 and a lateral direction or axis 63. In some embodiments, the vertical direction 61 and the lateral direction 63 may be substantially perpendicular to each other.

Focusing now on FIG. 3, the mobile chair 20 may include wheels 62, handles 64, a back rest portion 66, a seat portion 68, arm rests 70, the transfer device 60, one or more actuators 72, a control device 74, a support element 76, one or more vertical stops 78, or a combination thereof. In some embodiments, the back rest portion 66 and the seat portion 68 may be referred to as a chair portion 80. Further, in some embodiments, the wheels 62 and other structural elements 81 (e.g., beams, rods, etc.) configured to provide support to the chair portion 80 may be referred to as a base portion 83. Moreover, it is to be understood that the mobile chair 20 may include additional features that may not be discussed or shown, but would be utilized in the function of the mobile chair 20, as discussed herein.

In the currently illustrated embodiment of FIG. 3, the mobile chair 20 is in the mobile configuration 40. While in the mobile configuration 40, the mobile chair 20 may utilize the wheels 62 to move across the floor 44. Indeed, in some embodiments, a braking system of the mobile chair 20 may be disengaged while the mobile chair 20 is in the mobile configuration 40. In some embodiments, a person may utilize the handles 64 to push the mobile chair 20. In some embodiments, the passenger of the mobile chair 20 may utilize the wheels 62 to self-propel the mobile chair 20. In some embodiments, the mobile chair 20 may include an internal motor and input devices. The input devices may be communicatively coupled to the internal motor and may actuate the internal motor based on inputs received from the passenger.

The actuators 72 may be any suitable actuators, such as hydraulic or electrical actuators, configured to adjust a height of the chair portion 80 relative to the base portion 83 in the vertical direction 61. The actuators 72 may be communicatively coupled to the control device 74. For example, the control device 74 may receive an input from a person, and may activate the actuators 72 to raise or lower the chair portion 80 of the mobile chair 20 based on the input. In some embodiments, the control device 74 may be a pedal, and the actuators 72 may be pneumatic actuators (e.g., pneumatic lifts). In such embodiments, the control device 74 may be pressed (e.g., activated, triggered) to adjust a pneumatic pressure in the actuators 72 to adjust the height of the chair portion 80. In some embodiments, the actuators 72 and the control device 74 may be part of an elevation adjustment system 85.

The vertical stops 78 are configured to limit a displacement of the mobile chair 20 in the vertical direction 61. For example, the vertical stops 78 may be positioned at a particular elevation along sides of the back rest portion 66 to set a minimum height and a maximum height for the mobile chair 20. In other words, the vertical stops 78 may be positioned to set the transfer height 46, as shown in FIG. 5, and/or the mobile height 48, as shown in FIG. 3. For example, while the mobile chair 20 is in the mobile configuration 40, and the mobile chair 20 is at the mobile height 48, the vertical stops 78 are configured to contact the arm rests 70 (or other suitable component) to block the chair portion 80 from moving below the desired mobile height 48. As will be appreciated, the vertical stops 78 may also be adjusted to be positioned to limit the transfer height 46, as shown in FIG. 5. Particularly, as the chair portion 80 is raised to the transfer height 46, the seat portion 68 may contact the vertical stops 78 when the chair portion 80 reaches the transfer height 46 to block further displacement above the transfer height 46. Generally, the vertical stops 78 may be positioned based on a height of the ride vehicle 14. As such, the vertical stops 78 may be adjusted to respective appropriate positions for different ride vehicles 14 to account for varied heights of ride vehicles 14. In some embodiments, the vertical stops 78 may be coupled to the mobile chair 20 via pins such that a user may remove/insert the pins from various heights along the mobile chair 20 (e.g., along the back rest portion 66) to set the minimum and maximum heights of the mobile chair 20.

Further, the transfer device 60 may be coupled to the vertical stops 78. While the mobile chair 20 is in the mobile configuration 40, the transfer device 60 may be rotated about the vertical stops 78 toward a rear of the mobile chair 20, as shown. Specifically, the transfer device 60 being positioned toward the rear of the mobile chair 20 may decrease a footprint of the mobile chair 20 in the lateral direction 63, which may increase a mobility of the mobile chair 20.

As discussed in further detail below, the transfer device 60 may be rotated about the vertical stops 78 to be substantially coplanar with the seat portion 68 when the mobile chair 20 is in the transfer configuration 42. In other words, while in the transfer configuration 42, the transfer device 60 may extend laterally 63 from edges 86 of the seat portion 68 in the lateral direction 63.

FIG. 4 is a perspective view of the mobile chair 20 in the intermediate configuration 58. In some embodiments, the mobile chair 20 may transition to the intermediate configuration 58 as an intermediate stage while transitioning between the mobile configuration 40 and the transfer configuration 42. As shown, the mobile chair 20 may be at the transfer height 46 and the vertical stops 78 may be engaged with the edges 86 of the seat portion 68 to block the chair portion 80 from moving above the transfer height 46. In some embodiments, the edges 86 of the seat portion 68 may be defined by beams, or other structural elements, disposed adjacent to a seat pad 87 of the seat portion 68. Further, as shown and mentioned above, the transfer device 60 may be coupled to the vertical stops 78. Accordingly, as will be appreciated, deployment of the transfer device 60 may position the transfer device 60 approximately level with the seat portion 68, such that the transfer device 60 extends from the seat portion 68 in the lateral direction 63.

FIG. 5 is a perspective view of the mobile chair 20 in the transfer configuration 42. As shown, while the mobile chair 20 is in the transfer configuration 42, the transfer device 60 may be deployed such that the transfer device 60 is positioned to extend from the edge 86 of the seat portion 68 in the lateral direction 63. Further, as shown, the support element 76 may be deployed to provide support to the transfer device 60. In some embodiments, the support element 76 may be coupled to the edge 86 of the seat portion 68 via a hinge 88 such that the support element 76 may rotate about the hinge 88 to extend in the lateral direction 63 to contact and provide support to the transfer device 60.

Further, as shown, while the mobile chair 20 is in the transfer configuration 42, the arm rests 70 may be moved (e.g., rotated, repositioned) to extend along sides 89 of the back rest portion 66. More generally, the arm rests 70 may be repositioned such that the passenger may move from the seat portion 68 to the transfer device 60 without the arm rests 70 blocking movement of the passenger.

Indeed, once the mobile chair 20 is in the transfer configuration 42, the passenger of the mobile chair 20 may move from the chair portion 80 to the transfer device 60. In other words, the passenger may initially be fully supported by the seat portion 68, and may move (e.g., slide) across the edge 86 of the seat portion 68 to the transfer device 60 where the passenger may be fully supported by the transfer device 60. Particularly, as shown, the transfer device 60 may include a platform 90 configured to support the passenger. The passenger may then move from the transfer device 60 to the ride seat 30 of the ride vehicle 14. As illustrated in the current embodiment, the transfer device 60 may extend in the lateral direction 63 beyond the wheels 62 of the mobile chair 20.

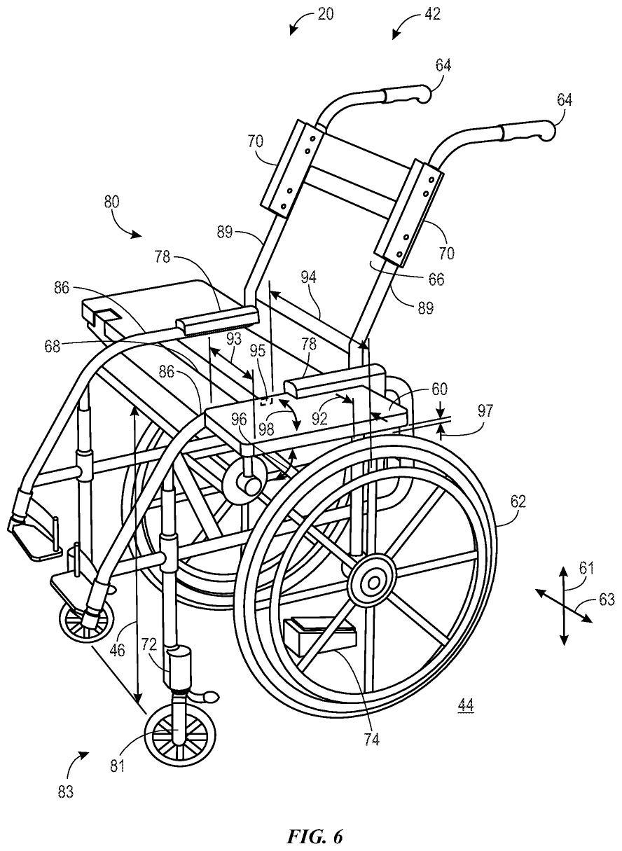

In some embodiments, the transfer device 60 may extend in the lateral direction 63 a distance from the edge 86 of the seat portion 68 that is substantially equal to, or slightly greater than, a width 92 (measured in the lateral direction 63) of the wheels 62. To illustrate, FIG. 6 is a perspective view of the mobile chair 20 in the transfer configuration 42, wherein the mobile chair 20 includes the transfer device 60, which may rotate from beneath or above the seat portion 68 of the mobile chair 20. As illustrated in the current embodiment, the transfer device 60 may extend in the lateral direction 63 a first distance 93 from the edge 86 of the seat portion 68. Further, the wheels 62 may extend in the lateral direction 63 a second distance 94 from the edge 86 of the seat portion 68. The second distance 94 may be substantially equal to, or slightly greater than, the width 92 of the wheels 62. Moreover, the first distance 93 may be substantially equal to, or slightly greater than, the second distance 94. In this way, the mobile chair 20 may be positioned substantially directly adjacent to the ride vehicle 14. For example, the seat portion 68 may be positioned approximately the second distance 94 away from the ride vehicle 14 such that the transfer device 60 may contact the wall 52 of the ride seat 30 (FIG. 2), or may overlap with a portion of the ride seat 30 to facilitate transfer of the passenger into the ride vehicle 14. Indeed, due to the minimal width (e.g., the first distance 93) of the transfer device 60, the passenger may efficiently transfer from the mobile chair 20 to the ride seat 30.

Further, in some embodiments, the transfer device 60 may be directly coupled to the edges 86 of the seat portion 68 via a hinge 95. In this way, the transfer device 60 may be deployed (e.g., rotated) in a first direction 96 from beneath the seat portion 68. Accordingly, in some embodiments, the width (e.g., the first distance 93) of the transfer device 60 may be less than a clearance 97 between the edge 86 of the seat portion 68 and the wheels 62. Particularly, while the mobile chair 20 is in the transfer configuration 42, the seat portion 68 may be raised to the transfer height 46. While the seat portion 68 is at the transfer height 46, the seat portion 68 may be distanced from the wheels 62 by the clearance 97, which may be sufficient to enable rotation of the transfer device 60 in the first direction 96 between the seat portion 68 and the wheels 62. Further, in some embodiments, the transfer device 60 may be rotated in a second direction (as shown by arrow 98) from above the seat portion 68 to extend in the lateral direction 63 from the seat portion 68.

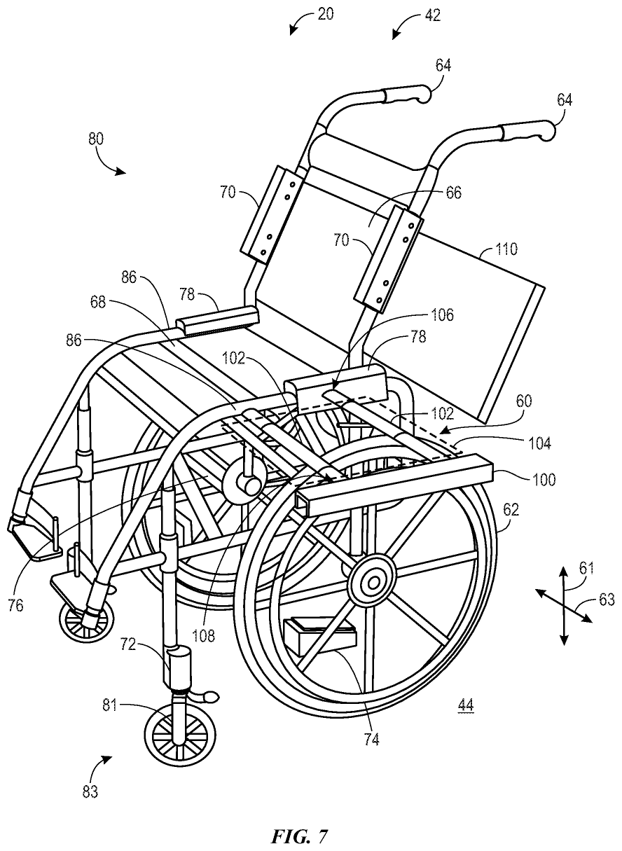

FIG. 7 is a perspective view of an embodiment of the mobile chair 20 in the transfer configuration 42, wherein the mobile chair 20 has a mounting element 100 and an extension 102. As shown, in some embodiments, the transfer device 60 may include the mounting element 100, the one or more extensions 102, an accessory element 104, or a combination thereof. As discussed in further detail below, the mounting element 100 may be configured to mount to a side (e.g., the wall 52) of the ride seat 30 of the ride vehicle 14. Particularly, the mounting element 100 may include one or more features configured to engage with the ride seat 30, such as a clip, a vise, or any other suitable mechanism configured to engage or couple to a corresponding element of the ride vehicle 14. In some embodiments, the mounting element 100 may extend from the edge 86 of the seat portion 68 via the extension 102. In some embodiments, the extension 102 includes two telescoping arms that are coupled to the seat portion 68 at a first end 106 of the extensions 102 and coupled to the mounting element 100 at a second end 108 of the extensions 102. Accordingly, the mounting element 100 may extend from or retract toward the mobile chair 20 via the extensions 102.

Further, in some embodiments, the transfer device 60 may include the accessory element 104. The accessory element 104 may be a detachable platform configured to couple to the extensions 102, the mounting element 100, or any other suitable component of the transfer device 60 and/or the mobile chair 20. Generally, the accessory element 104 may provide a surface configured to provide support to the passenger as the passenger transfers from the mobile chair 20 to the ride seat 30. For example, the accessory element 104 may provide the functionality of the platform 90 of the transfer device 60 as described above in reference to FIG. 5.

Further, in some embodiments, the transfer device 60 may include a back support portion 110 configured to extend from the back rest portion 66 of the mobile chair 20 in the lateral direction 63. In this way, the passenger may be provided with additional support from the back support portion 110 as the passenger moves across the transfer device 60 toward the ride seat 30. In some embodiments, the arm rest 70 may be configured to rotate to extend in the lateral direction 63 from the side 89 of the back rest portion 66 to function as the back support portion 110. It should be appreciated that instead of the separate accessory element 104, a platform may be positioned on top of the extensions 102 and slide with the extensions 102 from underneath the seat portion 68 and/or the extensions 102 may form a platform (e.g., a telescoping platform). The accessory element 104 is shown in dotted lines to facilitate visualization of the extension 102.

Further, in some embodiments, the chair portion 80 and/or the seat portion 68 may be configured to move (e.g., slide) along the extension 102. In other words, the seat portion 68 and/or the chair portion 80 may be configured to translate relative to the base portion 83 of the mobile chair 20 along the extension 102 and toward the ride seat 30. In this way, the seat portion 68 may be positioned on the transfer device 60 and directly adjacent to the ride seat 30 such that the passenger may transfer from the seat portion 68 to the ride seat 30 without first transferring to an intermediate segment, such as the accessory element 104 or the platform 90, of the transfer device 60.

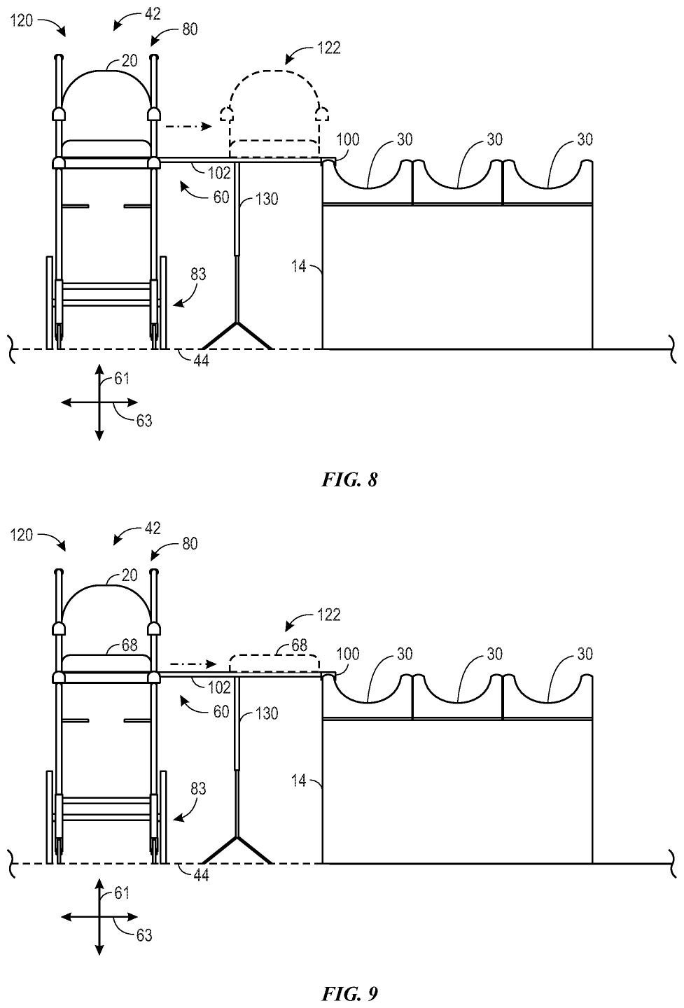

To further illustrate, FIGS. 8 and 9 are schematic views of embodiments of the mobile chair 20 in the transfer configuration 42 positioned adjacent to the ride seat 30. Particularly, FIG. 8 is a schematic view of the mobile chair 20 having the chair portion 80 configured to be translated along the extension 102 of the transfer device 60. For example, as shown, the chair portion 80 may be translated along the extension 102 from a first position 120 to a second position 122 relative to the base portion 83. While in the first position 120, the chair portion 80 may be disposed above the base portion 83 of the mobile chair 20 in the vertical direction 61. From the first position 120, the chair portion 80 may slide along the extension 102 to the second position 122. While in the second position 122, the chair portion 80 may be disposed directly adjacent to the ride seat 30, as shown. While the chair portion 80 is in the second position 122, the passenger may transfer directly from the chair portion 80 to the ride seat 30.

Further, as discussed above, in some embodiments, the transfer device 60 may be configured to engage with the ride seat 30, such as via the mounting element 100. Accordingly, in such embodiments, the transfer device 60 may be at least partially supported by the ride seat 30. Additionally or in the alternative, the mobile chair 20 may include a vertical support 130. The vertical support 130 may be coupled to the transfer device 60 and may contact the floor 44 to provide support to the transfer device 60 (and the passenger) in the vertical direction 61. In other words, the transfer device 60 may be at least partially supported by the vertical support 130. In some embodiments, the vertical support 130 may be detachable from the transfer device 60. In some embodiments, the vertical support 130 may fold toward the transfer device 60 for storage purposes.

FIG. 9 is a schematic view of the mobile chair 20 in the transfer configuration 42, wherein the seat portion 68 of the mobile chair 20 is supported on the extension 102. As illustrated in the current embodiment, the seat portion 68 may be configured to translate (e.g., separately from the back rest portion 66 of the chair portion 80) along the extension 102. For example, as shown, the seat portion 68 may be translated along the extension 102 from the first position 120 to the second position 122. As discussed above, while in the first position 120, the seat portion 68 may be disposed above the base portion 83 of the mobile chair 20 in the vertical direction 61. From the first position 120, the seat portion 68 may slide along the extension 102 to the second position 122. While in the second position 122, the seat portion 68 may be disposed directly adjacent to the ride seat 30, as shown. While the seat portion 68 is in the second position 122, the passenger may transfer directly from the chair portion 80 to the ride seat 30.

Further, while the transfer device 60 may be shown and discussed herein as extending in the lateral direction 63 and being substantially level (e.g., relative to the floor 44), in some embodiments, the transfer device 60 may be angled downward toward the ride seat 30 from the seat portion 68 of the mobile chair 20. For example, the transfer height 46 of the mobile chair 20 may be such that the edge 86 of the seat portion 68 may be disposed at a higher elevation than the ride seat 30 in the vertical direction 61. Accordingly, the transfer device 60 may be sloped downward from the edge 86 of the seat portion 68 toward the ride seat 30. In this manner, the transfer device 60 may utilize gravitational forces to assist the passenger in moving across the transfer device 60 to the ride seat 30.

In some embodiments, the passenger may exit the ride seat 30 by moving along the transfer device 60 from the ride seat 30. Accordingly, in some embodiments, the transfer device 60 may be sloped downward from the ride seat 30 to the seat portion 68 of the mobile chair 20.

While only certain embodiments have been illustrated and described herein, many modifications and changes will occur to those skilled in the art. It is therefore to be understood that the appended claims are intended to cover all such modifications and changes as fall within the true spirit of the invention. Features of FIGS. 1-9 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. A passenger transfer system, comprising:
a mobile chair having a base portion with a plurality of wheels and a chair portion configured to support a passenger;
an elevation adjustment system configured to adjust a height of the chair portion relative to the base portion; and
a transfer device configured to extend laterally from an edge of the chair portion, wherein the transfer device is configured to support the passenger as the passenger transfers from the chair portion to a ride seat of a ride vehicle of an attraction of an amusement park.

2. The passenger transfer system of claim 1, wherein the transfer device is configured to engage with the ride seat of the ride vehicle.

3. The passenger transfer system of claim 1, wherein the chair portion is configured to move laterally across the transfer device.

4. The passenger transfer system of claim 3, wherein the chair portion is configured to move relative to the base portion between a first position coupled to or on the base portion and a second position on the transfer device.

5. The passenger transfer system of claim 1, wherein the transfer device comprises a platform configured to support the passenger.

6. The passenger transfer system of claim 5, wherein the platform is detachable from the transfer device.

7. The passenger transfer system of claim 1, wherein the elevation adjustment system includes a stop configured to limit a maximum elevation increase of the chair portion.

8. The passenger transfer system of claim 1, wherein the elevation adjustment system includes one or more hydraulic actuators configured to adjust the height of the chair portion.

9. A mobile chair, comprising:
a base portion;
an adjustable-height seat portion configured to support a passenger, wherein the adjustable-height seat portion is adjustable relative to the base portion between a first position and a second position on the base portion;
one or more vertical stops fixedly coupled to the base portion at the second position; and
a transfer device rotatably coupled to one or both of the base portion or the one or more vertical stops and configured to rotate between a storage position and a transfer position, wherein the transfer position of the transfer device is substantially coplanar with the second position of the adjustable-height seat portion and wherein the adjustable-height seat portion is configured to slide towards an edge of the transfer device and away from the base portion when in the second position.

10. The mobile chair of claim 9, wherein the one or more vertical stops prevent adjustment of the adjustable-height seat portion beyond the second position on the base portion.

11. The mobile chair of claim 9, wherein the transfer device comprises a mating feature configured to engage with a passenger seat of a ride vehicle.

12. The mobile chair of claim 9, comprising one or more hydraulic actuators configured to adjust the height of the adjustable-height chair portion between the first position and the second position.

13. The mobile chair of claim 9, comprising a vertical support coupled to the transfer device.

14. The mobile chair of claim 9, comprising one or more arm rests coupled to the adjustable-height seat portion and configured to move with the seat portion between the first position and the second position.

15. The mobile chair of claim 14, wherein the one or more arm rests are configured to engage with the one or more vertical stops when the adjustable-height seat portion is in the first position.
